(19) United States
(12) Patent Application Publication
(10) Pub. No.: US 2004/0111292 A1
(43) Pub. Date: Jun. 10, 2004

(54) Healthcare credit evaluation method

(76) Inventor: Patton A. Hutchins, Wilmington, NC (US)

Correspondence Address: WILLIAM J. MASON, MACCORD MASON PLLC, POST OFFICE BOX 1489, WRIGHTSVILLE BEACH, NC, 28480, US

(21) Appl. No.: 10/314,039

(22) Filed: Dec. 6, 2002

(51) Int. Cl. G06F 17/60

(52) U.S. Cl. 705/2; 705/38

(57) ABSTRACT

The creditworthiness of a recipient of healthcare services is obtained by accessing a database containing credit information relating only to payment of healthcare-related charges by a plurality of healthcare recipients; retrieving the recipient's payment history information; and evaluating the granting of credit using the payment history information retrieved. The database is also used to select a strategy to be used in collecting an overdue invoice to a healthcare recipient. A credit rating score is assigned to the delinquent recipient based on the payment history of the delinquent recipient as determined by information in the database, and each strategy is assigned a value corresponding to possible credit rating scores.

### BACKGROUND OF THE INVENTION

(1) Field of the Invention

The present invention relates to a procedure for evaluating the credit worthiness and payment histories of current and potential patients, and in particular to a method for determining which of a number of strategies to use in collecting past due healthcare-related debt.

(2) Description of the Prior Art

Healthcare organizations, and in particular hospitals and other healthcare treatment facilities, lose substantial revenues due to their inability to effectively collect past due charges for healthcare services. A great deal of time and expense is also incurred in attempting, often unsuccessfully, to collect such debts.

Many healthcare providers, the term including both physicians and other practitioners, as well as hospitals and other treatment facilities, attempt to minimize their exposure, when possible, by treating patients with insurance, and by accepting credit card payments. However, these alternatives are not always available. In the absence of insurance or credit card availability, the provider, upon receiving a request for healthcare services, must make a judgment call regarding the likelihood that the prospective patient will pay, or refuse to provide the services, which is not always possible.

While the provider may attempt to evaluate creditworthiness through the use of credit reporting agencies, the assessment is frequently incorrect. As a result, the provider must expend considerable time and expense in attempting to collect overdue accounts. Thus, there is a continuing need for a system that would aid the provider in initially evaluating the creditworthiness of prospective patients and, when overdue accounts do occur, in determining the most cost effective strategy to use in collecting the debt.

### SUMMARY OF THE INVENTION

The present invention is founded on the recognition that patients or healthcare recipients, the terms being used interchangeably, having overdue accounts, whether to healthcare facilities or to healthcare practitioners, do not treat such overdue accounts in the same way that they treat overdue accounts to others, such as credit card agencies. Specifically, a patient with accounts that are payable to several entities, including one or more healthcare providers, will often pay the non-healthcare related accounts first, and pay the healthcare provider only after payment of the other accounts. In fact, payments may be made to keep other accounts current, even when the payment to the healthcare provider is overdue. The difference in treatment of healthcare related debt is believed to be due, at least in part, to the general belief that many healthcare providers will simply “write-off” the uncollected debt, with little consequence to the debtor.

Thus, an attempt to determine the creditworthiness of a patient, i.e., the likelihood that a patient will pay an invoice, based on the patient's general creditworthiness is frequently of little value, and often misleading, since a credit record may reflect only, or primarily, the patient's past performance in paying non-healthcare related credit invoices. In accordance with the present invention, a database is created that contains only information pertaining to the payment histories of healthcare related debts by patients. This database, which can be a free-standing database, or a subset of a larger database, is used to effectively access the creditworthiness of prospective patients, reducing the likelihood of overdue payments, and to evaluate alternative collection strategies when overdue invoices exist.

More specifically, the present database is compiled by receiving information relating to patient payment histories from a plurality of sources, including healthcare providers, who may be users of the database, e.g., through a subscription to use the database service. The information may include the patient's name, address and contact information; the dates when services were rendered, the original charge for the services, and the outstanding balances. The provider's name may also be provided to facilitate any payments by the patient. Access to the database is limited to subscribing healthcare providers who agree to limit their use of the information solely to the evaluation of creditworthiness of patients.

When a healthcare provider receives a request for credit from a potential patient, the provider may access the database to determine if the patient has a history of non-payment of healthcare related debts. If so, the provider may refuse treatment, or require payment in advance, or other secure form of payment, before healthcare services are rendered. Since the database information is limited to a prospective patient's payment history with respect only to previous healthcare debt, and is not distorted by payment history with respect to other types of debt, the accuracy of the credit assessment is greatly enhanced.

Since an individual's circumstances may change, a clean credit history, even specific to previous healthcare debt payment, is no guarantee that a debt will be timely paid when the provider extends credit. Thus, late payment of invoices will still occur. Considerable time and cost is expended by healthcare providers, in particular hospitals, in attempting to collect overdue invoices. Several invoice collection strategies may be used, with the collection strategy depending on the time that the debt is overdue and the amount of the debt. Generally, except for these factors, all debts prior to the present invention have been treated equally, and the same strategy has been adopted for debts that are equally overdue and for approximately the same amount. The likelihood that the patient will pay has been largely ignored.

In accordance with the present invention, the patient's likelihood of paying the debt is taken into account by determining how the patient has treated healthcare payment debt in the past. With this additional information, the healthcare provider is better able to determine which of various collection strategies can best be implemented in collecting a specific debt.

### DETAILED DESCRIPTION OF THE INVENTION

Unlike prior art databases used by credit reporting agencies, the present database excludes credit information relating to non-healthcare credit activities. The database is preferably accessed over the Internet using an Internet Services Provider in a known manner. Passwords are assigned to qualified users to protect the confidentiality of the database content.

The database content can be comprised of information selected from data provided by users, selected data from credit reporting agencies and/or data from collection agencies. This data can be further restricted, e.g., to information relating only to bad debts.

Access to the database is limited to qualified healthcare providers, such as hospitals, physicians, dentists, chiropractors, pharmacists, home health agencies, and suppliers of goods and services to healthcare professionals and patients. Each user is required to follow defined procedures in order to be granted access to the database. In particular, each user must obtain the written permission of each patient, whether an existing or prospective patient, before the database is accessed for information relating to the patient.

In order to evaluate the creditworthiness of a prospective patient, the healthcare provider first obtains the written permission of the patient to access the database, generally by having the patient sign a consent form generally allowing the healthcare provider to contact third parties to obtain credit information, and patient identifying information, usually including the patient's social security number.

The healthcare provider then accesses the website of the database provider using a computer connected to the Internet, and accesses the database by entering a password, or a userid and password combination. Once into the database, the user enters the patient identifying information, e.g., the patient's social security number. Information relating to the payment history of the designated patient is then provided to the user. This information may be in the form of all data in the database relating to the patient, in summary form, or in the form of a credit rating score, e.g., a numerical value.

Provision of a credit rating in the form of a score enables the user to quickly determine what action is to be taken with respect to the granting of credit. For example the management of a user organization can establish a plurality of actions to be taken with respect to a credit request, with a rating or value being assigned to each of the possible actions. When a score for a given patient is received, a decision can be quickly made by comparing the score with the ratings for each possible action. Thus, procedures can be implemented by clerical personnel based on the guidelines established by management.

A similar procedure is followed when the healthcare provider is determining which of several collection procedures to adopt in attempting to collect an overdue debt. For example, hospitals frequently have a large number of overdue accounts. Hospitals often use internal personnel to attempt to collect such debts using different collection methods, normally based on letter writing, telephone calls, or a combination of these two methods. When internal methods fail, the debt is often assigned to a collection agency, who attempts collection for a percentage of the amount recovered. Alternatively, the debt or a group of debts, are sold to a third party who attempts to collect the amounts owed.

Frequently, considerable time and money is expended in attempting to collect an overdue amount with one collection strategy when another strategy would be more appropriate. For example, attempts are often made to collect a debt through mail and/or telephone calls, when immediate assignment of the debt to a collection agency would be more successful. Determination of the appropriate, and thereby most effective and economical collection strategy, is also possible using the above database.

When using the database for this purpose, the user accesses the database in the manner described above and credit information is retrieved for each patient for whom patient identifying information is entered. Based on this information, the user can then determine which strategy to adopt in attempting collection.

In a preferred embodiment, credit information is provided as a credit rating score, and each collection strategy is assigned a value corresponding to a credit rating score. The user can then simply select the appropriate strategy by seeing which strategy ratings corresponds to the retrieved credit rating score. For example, the following scoring system may be used:

400—Patient has no outstanding healthcare debts

300—Patient has 1 outstanding healthcare debt

200—Patient has 2-5 outstanding healthcare debts

100—Patient has 6 or more outstanding healthcare debts

The Corresponding strategies might be used:

For a 400 score—2 statements and collector follow-up within 90 days

For a 300 score—1 statement and 1 follow-up telephone call

For a 200 score—1 statement and no follow-up telephone call

For a 100 score—outsource to a third party

Thus, by using the above database, a hospital or other healthcare provider can quickly determine the strategy to be used for a given debt.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method for evaluating the creditworthiness of a recipient of healthcare services comprising:
a) obtaining recipient identifying information;
b) accessing a database containing credit information relating only to payment of healthcare-related charges by a plurality of healthcare recipients;
c) retrieving recipient payment history information; and
d) evaluating the granting of credit using the payment history information retrieved.

2. The method of claim 1, further including the step of periodically adding information to said database relating to the payment history of one or more healthcare recipients.

3. The method of claim 1, wherein said database is a computerized database accessible over the Internet.

4. The method of claim 1, wherein said recipient identifying information includes the recipient's social security number.

5. The method of claim 1, wherein said payment history information is in the form of a credit rating score.

6. A method for providing information relating to the creditworthiness of a recipient of healthcare services comprising:
a) providing a database containing credit information relating only to payment of healthcare-related charges by a plurality of healthcare recipients;
b) providing password access to said database to a user; and
c) transmitting to the user credit information relating to the payment history of a selected recipient identified by recipient identifying information.

7. The method of claim 6, wherein said database is a computerized database accessible over the Internet.

8. The method of claim 6, wherein said recipient identifying information includes the recipient's social security number.

9. A method for evaluating the overdue account of a recipient of healthcare services to select a collection strategy to be used with respect to said account comprising:
a) accessing a payment history database that includes credit information relating only to the healthcare payment histories of a plurality of recipients, including the recipient with said overdue account;
b) receiving information scoring the recipient based on the recipient's previous healthcare payment history as indicated by said database; and
c) assigning said account to one of a plurality of collection strategies based on said scoring.

10. The method of claim 9, wherein said database information is limited to the healthcare payment information.

11. The method of claim 9, wherein said database is comprised of information collected from healthcare providers selected from the group consisting of hospitals, clinics, physicians, and dentists.

12. The method of claim 9, wherein said account is assigned a numerical score determined by the results of said scoring and each of said strategies is used for accounts with a given numerical score.

13. The method of claim 9, wherein one of said collection strategies is to send at least one statement followed by at least one telephone call.

14. The method of claim 9, wherein one of said collection strategies is to send at least one statement without a telephone call.

15. The method of claim 9, wherein one of said collection strategies is to immediately assign the debt to a third party for collection.

16. The method of claim 9, wherein said data base is accessed over the Internet.

17. A method for providing information relating to the credit history of a delinquent healthcare recipient for use in selecting a strategy to be used in collecting an overdue invoice to said recipient comprising:
a) providing a payment history database that includes credit information relating only to the healthcare payment histories of a plurality of healthcare recipients, including said delinquent recipient;
b) providing user password access to said database;
c) assigning a credit rating score to said delinquent recipient based on the payment history of said delinquent recipient as determined by information in said database; and
d) transmitting said credit rating score to the user.

18. The method of claim 16, wherein said credit rating score is provided as a numerical value.

19. The method of claim 17, wherein said credit rating score is transmitted over the Internet.
